(19) United States
(12) Patent Application Publication
(10) Pub. No.: US 2017/0009110 A1
(43) Pub. Date: Jan. 12, 2017

(54) POLYOLEFIN RESIN COMPOSITION FOR HOT MELT ADHESIVE, HOT MELT ADHESIVE FILM, AND LAMINATE

(71) Applicant: KANEKA CORPORATION, Osaka-shi (JP)

(72) Inventors: Arihiro Saito, Osaka (JP); Ryoji Nakayama, Osaka (JP)

(73) Assignee: Kaneka Corporation, Osaka (JP)

(21) Appl. No.: 15/113,072

(22) PCT Filed: Jan. 15, 2015
(86) PCT No.: PCT/JP2015/050871

§ 371 Date: Jul. 21, 2016

(30) Foreign Application Priority Data
Jan. 22, 2014 (JP) 2014-009138

(51) Int. Cl. C09J 123/16; C09J 151/06

(52) U.S. Cl. CPC C09J 123/16; C09J 151/06

(57) ABSTRACT

A polyolefin resin composition for hot melt adhesives includes 5 to 95% by weight of (A) an ethylene-α-olefin copolymer having a melting point of at least 100° C. but not more than 140° C.; and 5 to 95% by weight of (B) an ethylene-α-olefin copolymer having a melting point of at least 70° C. but less than 100° C.

### TECHNICAL FIELD

The present invention relates to a polyolefin resin composition for hot melt adhesives and, more specifically, to a polyolefin resin composition for hot melt adhesives, which shows low-temperature adhesion and excellent heat resistance. The present invention also relates to a hot melt adhesive film.

### BACKGROUND

Thermoplastic resins such as thermoplastic elastomers, olefin polymers, vinyl polymers, and engineering plastics are excellent in properties such as physical properties, formability, and surface properties. Due to these properties, they are processed into a mass, a sheet, a film or other shapes according to the applications and used in many fields such as automobiles, household electrical appliances, electronics, buildings, and sundries. A plurality of formed articles of these resins are bonded and combined in order to produce a product having a desired shape or to enhance performance or diversify functions. In particular, a method is widely used, which involves stacking a covering material or decorating sheet excellent in surface properties, weather resistance, or decorativeness on the outer layer of a resin formed article having high mechanical properties as a base material. Such laminates are often used in automobile interiors, house interiors, and housings of household electrical appliances, for example. The laminates, however, generally have poor adhesion between the layers. Hence, in many cases, an adhesive layer is provided between the layers before stacking. As the adhesive, solvent-based adhesives and hot melt adhesives are used. Solvent-based adhesives are disadvantageous in that they tend to cause uneven coating and that they have harmful effects on environment or hygiene due to the use of organic solvents. Therefore, there is a need for hot melt adhesives which are easy to use and excellent in adhesion strength.

Examples of such hot melt adhesives that have been proposed include those which contain at least one base polymer selected from the group consisting of ethylene copolymers, styrene block copolymers, and olefin (co)polymers, together with a tackifier resin and a crystalline polar group-containing compound (Patent Literature 1), those which contain an amorphous poly-α-olefin, a tackifier resin, and a polypropylene wax as essential components (Patent Literature 2), those which are obtained by adding a tackifier resin component and a liquid plasticizer such as process oil to a styrene-ethylene/propylene-styrene block copolymer rubber or a styrene-butadiene-styrene block copolymer rubber (Patent Literatures 3 and 4), those which are obtained by mixing a modified polyolefin and a tackifier (Patent Literature 5), those which are obtained by mixing a styrene block copolymer and an acid-modified wax (Patent Literature 6), those which are obtained by mixing an acid-modified polypropylene and an acid-modified styrene block copolymer (Patent Literature 7), and those which are obtained by mixing a styrene block copolymer, a tackifier, and an ethylene polymer (Patent Literatures 8, 9, and 10).

However, when these hot melt adhesives are used in materials such as those for automobile interiors required to have a practical heat resistance of about 80° C., the covering material may come off or peel off in a high temperature atmosphere. The adhesion to resin base materials can, in some cases, be enhanced by applying a pressure at a heating temperature set to a relatively high temperature during bonding. However, when the laminates are used in applications requiring aesthetic quality, such as automobile interiors, house interiors, and housings of household electrical appliances, formed members may be damaged so that the aesthetic quality is spoiled. For this reason, hot melt adhesives have been desired which are capable of achieving both a low-temperature adhesion that is high but does not spoil the aesthetic quality, and a practical heat resistance.

### CITATION LIST

### Patent Literature

Patent Literature 1: JP H10-168417 A

Patent Literature 2: JP 2004-284575 A

Patent Literature 3: JP H03-160083 A

Patent Literature 4: JP H08-60121 A

Patent Literature 5: JP H06-293845 A

Patent Literature 6: JP 2007-169531 A

Patent Literature 7: JP 2008-163121 A

Patent Literature 8: JP H11-131037 A

Patent Literature 9: JP H10-279774 A

Patent Literature 10: JP H10-265751 A

### SUMMARY OF INVENTION

One or more embodiments of the present invention provide a polyolefin resin composition which, when used in the preparation of laminates for automobile interiors, house interiors, or housings of household electrical appliances, shows sufficient adhesion both to polar and nonpolar base materials even when the temperature during bonding is set low in consideration for aesthetic quality, and which also allows the laminates to satisfy the heat resistance required for the particular applications, and particularly has excellent heat resistance at temperatures as high as about 80° C.; and a hot melt adhesive film formed from the polyolefin resin composition.

As a result of intensive studies, the inventors have found that a resin composition containing ethylene-α-olefin copolymers having specific melting point ranges solves the challenge of achieving both the above-described low-temperature adhesion and heat resistance.

That is, one or more embodiments of the present invention include the following aspects.

(1) A polyolefin resin composition for hot melt adhesives, containing:

5 to 95% by weight of (A) an ethylene-α-olefin copolymer having a melting point of at least 100° C. but not more than 140° C.; and

5 to 95% by weight of (B) an ethylene-α-olefin copolymer having a melting point of at least 70° C. but less than 100° C.

(2) The polyolefin resin composition for hot melt adhesives according to aspect (1), further containing 1 to 60 parts by weight of (C) a styrenic thermoplastic elastomer per 100 parts by weight of the combined amount of the copolymers (A) and (B).

(3) The polyolefin resin composition for hot melt adhesives according to aspect (1) or (2), further containing 1 to 80 parts by weight of (D) a tackifier per 100 parts by weight of the combined amount of the copolymers (A) and (B).

(4) The polyolefin resin composition for hot melt adhesives according to any one of aspects (1) to (3),

wherein the polyolefin resin composition has a storage elastic modulus at 80° C., G′(80), of 0.8 MPa or more as measured in a shear mode at a frequency of 10 Hz, and a storage elastic modulus at 110° C., G′(110), of less than 0.8 MPa as measured in a shear mode at a frequency of 10 Hz.

(5) The polyolefin resin composition for hot melt adhesives according to any one of aspects (1) to (4),

wherein the ethylene-α-olefin copolymer (A) has a tensile elastic modulus of at least 300 MPa but not more than 700 MPa, and the ethylene-α-olefin copolymer (B) has a tensile elastic modulus of at least 50 MPa but less than 300 MPa.

(6) The polyolefin resin composition for hot melt adhesives according to any one of aspects (1) to (5),

wherein at least one of the ethylene-α-olefin copolymer (A) or the ethylene-α-olefin copolymer (B) is a modified ethylene-α-olefin copolymer which has been graft-modified with (a) an unsaturated carboxylic acid or a derivative thereof, and (b) an aromatic vinyl monomer.

(7) The polyolefin resin composition for hot melt adhesives according to any one of aspects (1) to (6),

wherein at least one of the ethylene-α-olefin copolymer (A) or the ethylene-α-olefin copolymer (B) is an ethylene-propylene copolymer.

(8) The polyolefin resin composition for hot melt adhesives according to any one of aspects (1) to (7),

wherein the ethylene-α-olefin copolymer (A) contains 3 to 10% by weight of ethylene-derived units.

(9) The polyolefin resin composition for hot melt adhesives according to any one of aspects (1) to (8),

wherein the ethylene-α-olefin copolymer (B) contains 5 to 15% by weight of ethylene-derived units.

(10) The polyolefin resin composition for hot melt adhesives according to any one of aspects (2) to (9),

wherein the styrenic thermoplastic elastomer (C) contains 20% by weight or less of styrene-derived units.

(11) The polyolefin resin composition for hot melt adhesives according to any one of aspects (2) to (10),

wherein the styrenic thermoplastic elastomer (C) is at least one selected from the group consisting of hydrogenated styrene-isoprene block copolymers, hydrogenated styrene-butadiene block copolymers, and hydrogenated styrene-butadiene random copolymers.

(12) The polyolefin resin composition for hot melt adhesives according to any one of aspects (3) to (11),

wherein the tackifier (D) is at least one selected from the group consisting of terpene resins, aromatic modified terpene resins, and alicyclic petroleum resins.

(13) A hot melt adhesive film, containing

the polyolefin resin composition for hot melt adhesives according to any one of aspects (1) to (12),

the hot melt adhesive film having a thickness of 20 to 200 μm.

(14) A laminate, containing

the polyolefin resin composition for hot melt adhesives according to any one of aspects (1) to (12).

(15) The hot melt adhesive film according to aspect (13), which is used in vacuum forming, vacuum pressure forming, or hot stamping.

The polyolefin resin composition according to one or more embodiments of the present invention ensures excellent adhesion both to nonpolar resins such as polyolefin resins and to polar resins such as acrylic resins and polycarbonate resins, which has been difficult to achieve. Since the polyolefin resin composition can be used for bonding especially at low temperatures and low pressures, it can be used in applications where a complex three-dimensionally shaped formed article and a covering material are stacked through vacuum forming, vacuum pressure forming, pressure forming, hot stamping or other forming processes.

Thus, the polyolefin resin composition can be suitably used for decoration of formed articles for automobile interiors, house interiors, or housings of household electrical appliances.

### DESCRIPTION OF EMBODIMENTS

Hereinafter, the present invention will be described in detail.

### (Ethylene-α-olefin copolymers (A) and (B))

The ethylene-α-olefin copolymer (A) used in one or more embodiments of the present invention has a melting point of at least 100° C. but not more than 140° C., and the ethylene-α-olefin copolymer (B) has a melting point of at least 70° C. but less than 100° C. The melting point is defined as a temperature corresponding to the top of a peak observed on a melting endothermic curve obtained with a differential scanning calorimeter by warming a sample in a nitrogen atmosphere at a rate of 10° C./min, cooling the sample, and then warming the sample again at a rate of 10° C./min.

The melting point of the ethylene-α-olefin copolymer (A) is preferably 105° C. or more, more preferably 110° C. or more. The melting point is also preferably 130° C. or less, more preferably 125° C. or less.

The melting point of the ethylene-α-olefin copolymer (B) is preferably 75° C. or more, more preferably 80° C. or more, but preferably 95° C. or less.

For example, in applications such as automobile interiors where a decorating sheet is stacked on the surface, the composition is generally required to maintain excellent adhesion even at temperatures as high as 80° C. or more. Also, products for these applications are produced by bonding and stacking of a covering material on a base formed article, for example, through vacuum forming or vacuum pressure forming. At this time, the adhesive layer in many cases is formed at a temperature in the range of 100° C. to 130° C. so that the covering material is not damaged. Under such circumstances, mixing the ethylene-α-olefin copolymers (A) and (B) having the respective melting points allows us to achieve both the adhesion and heat resistance.

The compositional ratio between the ethylene-α-olefin copolymers (A) and (B) is 5 to 95% by weight (A) and 5 to 95% by weight (B), preferably 10 to 80% by weight (A) and 20 to 90% by weight (B), more preferably 20 to 70% by weight (A) and 30 to 80% by weight (B), especially preferably 25 to 50% by weight (A) and 50 to 75% by weight (B). A copolymer (A) content of less than 5% by weight is not preferred because the resulting composition tends to show poor heat resistance. A copolymer (A) content of more than 95% by weight is not preferred either because the resulting composition tends to show poor wettability on the base material during bonding. In addition, a copolymer (A) content of 25% by weight or more is preferred because the resulting composition when bonded at low temperatures tends to show even better heat resistance in the thermal creep test. A copolymer (A) content of 50% by weight or less is also preferred because the resulting composition when bonded at low temperatures tends to show better peel strength.

The tensile elastic modulus of the ethylene-α-olefin copolymer (A) is preferably 300 MPa or more, more preferably 350 MPa or more. It is also preferably 700 MPa or less, more preferably 600 MPa or less. The tensile elastic modulus of the ethylene-α-olefin copolymer (B) is preferably 50 MPa or more, more preferably 100 MPa or more. It is also preferably less than 300 MPa, and more preferably 250 MPa or less. When the tensile elastic modulus falls within the range indicated above, both adhesion and heat resistance are easily achieved. The tensile elastic modulus is determined from the stress at a strain of 0.0005 and the stress at a strain of 0.0025 in a tensile test performed with an autograph at a rate of 1 mm/min using a No. 2(⅓) dumbbell specimen in accordance with JIS K7113.

Since, in general, hot melt adhesives are softened and bonded at a temperature equal to or higher than their melting points, and then cooled and solidified at a temperature equal to or lower than the melting points, if the bonding temperature and the required heat resistant temperature are close to each other, it is difficult to design such hot melt adhesives. However, when the ethylene-α-olefin copolymers (A) and (B) meeting the above requirements are used, both adhesion in low-temperature processing and heat resistance of the adhesive layer in the resulting laminate can be achieved.

Any ethylene-α-olefin copolymers (A) and (B) satisfying the above properties can be used. Still, the ethylene-α-olefin copolymer (A) may suitably be an ethylene-α-olefin copolymer having a density of 0.88 g/cm³ to 0.90 g/cm³, and the ethylene-α-olefin copolymer (B) may suitably be an ethylene-α-olefin copolymer having a density of 0.86 g/cm³ to 0.88 g/cm³. The density is measured in accordance with JIS K7112.

Examples of the α-olefin used to form the ethylene-α-olefin copolymers include α-olefins usually having 3 to 20 carbons such as propylene, 1-butene, 1-hexene, 4-methyl-1-pentene, 1-octen, 1-decene, 1-tetradecene, and 1-octadecene. Propylene is preferred from the standpoints of easy generation of radicals on the polyolefin during graft-modification and of heat resistance.

As to the proportions of the ethylene-derived units and the α-olefin-derived units in the ethylene-α-olefin copolymers, the ethylene-α-olefin copolymer (A) preferably contains 90 to 97% by weight of α-olefin-derived units and 3 to 10% by weight of ethylene-derived units, while the ethylene-α-olefin copolymer (B) preferably contains 85 to 95% by weight of α-olefin-derived units and 5 to 15% by weight of ethylene-derived units, because both adhesion and heat resistance tend to be easily achieved. When the ethylene-derived unit content is more than each of the ranges indicated above, a cross-linking reaction may occur preferentially in the ethylene moiety when the later-described modification is performed, with the result that the resulting composition may not only have reduced low-temperature adhesion, but may also fail to give an adhesive film with good appearance. The ethylene-α-olefin copolymers may be copolymerized with a third component such as other dienes or vinyl esters as long as the above-described heat properties are not impaired.

The ethylene-α-olefin copolymers may be in the form of particles or pellets, and their size and shape are not particularly limited.

Also, two or more types of copolymers (A) and/or two or more types of copolymers (B) may be used in combination.

Either or both of the ethylene-α-olefin copolymers (A) and (B) may be graft-modified with (a) an unsaturated carboxylic acid or a derivative thereof, and (b) an aromatic vinyl monomer. From the standpoint of adhesion to base materials having high polarity such as PC/ABS, it is particularly preferred that both of the ethylene-α-olefin copolymers (A) and (B) are modified. The copolymers (A) and (B) may each be obtained by modifying a mixture of two or more types of unmodified ethylene-α-olefin copolymers. In addition, the copolymers (A) and (B) may be simultaneously modified.

The unsaturated carboxylic acid or derivative thereof (a) is not particularly limited. Examples of the derivative include anhydrides, amides, imides, and esters. These derivatives may be suitably used alone or in combinations of two or more. Examples of the unsaturated carboxylic acid include acrylic acid, methacrylic acid, maleic acid, endo-bicyclo[2.2.1]-5-heptene-2,3-dicarboxylic acid (endic acid), fumaric acid, tetrahydrophthalic acid, itaconic acid, citraconic acid, crotonic acid, isocrotonic acid, and nadic acid. Specific examples of the derivative of the unsaturated carboxylic acid include malenyl chloride, maleimide, maleic anhydride, endic anhydride, methyl acrylate, acrylamide, methyl methacrylate, glycidyl methacrylate, methacrylamide, citraconic anhydride, itaconic anhydride, nadic anhydride, monomethyl maleate, dimethyl maleate, monomethyl fumarate, and dimethyl fumarate. Among these unsaturated carboxylic acids and derivatives thereof, acrylic acid, methacrylic acid, maleic anhydride, and glycidyl methacrylate are preferred, maleic anhydride or glycidyl methacrylate is more preferred from the standpoint of inexpensiveness, and glycidyl methacrylate is particularly preferred as being easily removed in the drying step after modification.

The amount of the unsaturated carboxylic acid or derivative thereof (a) to be added to 100 parts by weight of the ethylene-α-olefin copolymer is preferably 0.1 parts by weight or more, more preferably 0.3 parts by weight or more, still more preferably 1 part by weight or more, particularly preferably 2 parts by weight or more. The amount is also preferably 10 parts by weight or less, more preferably 8 parts by weight or less, still more preferably 6 parts by weight or less, particularly preferably 5 parts by weight or less. An addition amount of less than 0.1 parts by weight is not preferred because adhesion tends not to be sufficiently improved. An addition amount of more than 10 parts by weight is not preferred either because the byproduction of free polymers not contributing to grafting tends to increase and the resulting composition tends not to be obtained as a sheet- or film-shaped adhesive composition having a suitable shape and appearance.

In order to increase the graft ratio of the unsaturated carboxylic acid or derivative thereof, the aromatic vinyl monomer (b) is preferably added. Combining the aromatic vinyl monomer can reduce deterioration in mechanical properties resulting from scission of the polyolefin backbone, thereby allowing the adhesive composition to maintain heat resistance.

The aromatic vinyl monomer (b) is not particularly limited, but is preferably an aromatic vinyl monomer having 4 to 20 carbons, more preferably 6 to 15 carbons. Examples include styrene; methylstyrenes such as o-methylstyrene, m-methylstyrene, p-methylstyrene, α-methylstyrene, β-methylstyrene, dimethylstyrene, and trimethylstyrene; chlorostyrenes such as o-chlorostyrene, m-chlorostyrene, p-chlorostyrene, α-chlorostyrene, β-chlorostyrene, dichlorostyrene, and trichlorostyrene; bromostyrenes such as o-bromostyrene, m-bromostyrene, p-bromostyrene, dibromostyrene, and tribromostyrene; fluorostyrenes such as o-fluorostyrene, m-fluorostyrene, p-fluorostyrene, difluorostyrene, and trifluorostyrene; nitrostyrenes such as o-nitrostyrene, m-nitrostyrene, p-nitrostyrene, dinitrostyrene, and trinitrostyrene; vinylphenols such as o-hydroxystyrene, m-hydroxystyrene, p-hydroxystyrene, dihydroxystyrene, and trihydroxystyrene; divinylbenzenes such as o-divinylbenzene, m-divinylbenzene, and p-divinylbenzene; and diisopropenylbenzenes such as o-diisopropenylbenzene, m-diisopropenylbenzene, and p-diisopropenylbenzene. These may be used alone or in combinations of two or more. Among these, styrene, methylstyrenes such as α-methylstyrene and p-methylstyrene, divinylbenzene monomers, and divinylbenzene isomer mixtures are preferred because they are inexpensive.

The amount of the aromatic vinyl monomer (b) to be added to 100 parts by weight of the ethylene-α-olefin copolymer is preferably 0.1 parts by weight or more, more preferably 0.3 parts by weight or more, still more preferably 1 part by weight or more, particularly preferably 2 parts by weight or more. The amount is also preferably 10 parts by weight or less, more preferably 8 parts by weight or less, still more preferably 6 parts by weight or less, particularly preferably 5 parts by weight or less. An addition amount of less than 0.1 parts by weight is not preferred because the graft ratio of the unsaturated carboxylic acid or derivative thereof to the ethylene-α-olefin copolymer tends to be poor. Also, an addition amount of more than 10 parts by weight is not preferred because the graft efficiency of the unsaturated carboxylic acid or derivative thereof may reach a saturation level and, at the same time, the cross-linking reaction may proceed excessively, resulting in reduced adhesion.

The grafted amount of the unsaturated carboxylic acid or derivative thereof in the modified ethylene-α-olefin copolymer is preferably 0.01 to 5% by weight per 100 parts by weight of the base resin. The grafted amount refers to the amount of the unsaturated carboxylic acid or derivative thereof introduced into the backbone of the base resin by graft copolymerization. A grafted amount of less than 0.01% by weight is not preferred because the resulting composition may show insufficient adhesion to some adherends. A grafted amount of more than 5% by weight is not preferred either because graft chains react with each other so that they are partially cross-linked during melt-kneading, resulting in poor formability as well as deteriorated product appearance due to defects such as fish eyes or spots, and reduced adhesion.

The modified ethylene-α-olefin copolymers may be prepared by usual radical grafting methods such as a melt-kneading method, a solution-based method, or a suspension method. Among these, the melt-kneading method is preferred because it is economical, simple, and productive.

As the radical polymerization initiator used in the radical grafting method, organic peroxides can generally be used. For example, in view of high hydrogen-abstraction ability, preferred are peroxy ketals such as 1,1-bis(t-butylperoxy)-3,3,5-trimethylcyclohexane, 1,1-bis(t-butylperoxy)cyclohexane, n-butyl-4,4-bis(t-butylperoxy)valerate, and 2,2-bis(t-butylperoxy)butane; dialkyl peroxides such as dicumyl peroxide, 2,5-dimethyl-2,5-di(t-butylperoxy)hexane, 1,3-di(t-butylperoxy-isopropyl)benzene, t-butylcumyl peroxide, di-t-butyl peroxide, and 2,5-dimethyl-2,5-di(t-butylperoxy)hexyne-3; diacyl peroxides such as benzoyl peroxide; and peroxy esters such as t-butyl peroxyoctoate, t-butyl peroxyisobutyrate, t-butyl peroxylaurate, t-butyl peroxy-3,5,5-trimethyl hexanoate, t-butyl peroxyisopropyl carbonate, 2,5-dimethyl-2,5-di(benzoylperoxy)hexane, t-butyl peroxyacetate, t-butyl peroxybenzoate, and di-t-butyl peroxyisophthalate. These may be used in combinations of two or more.

The amount of the radical polymerization initiator to be added to 100 parts by weight of the ethylene-α-olefin copolymer is preferably 0.01 parts by weight or more. Also, the amount is preferably 10 parts by weight or less, more preferably 5 parts by weight or less, still more preferably 2 parts by weight or less. An amount of less than 0.01 parts by weight may not allow the modification to sufficiently proceed. An amount of more than 10 parts by weight may reduce adhesion due to reduced fluidity or increased gel content caused by the cross-linking reaction.

Regarding the addition order and method in melt-kneading, the addition order is preferably such that the ethylene-α-olefin copolymer and the radical polymerization initiator are melt-kneaded to give a mixture, the unsaturated carboxylic acid or derivative thereof and the aromatic vinyl monomer are added to the mixture and they are melt-kneaded. This is because the above addition order leads to reduced generation of low molecular weight products that do not contribute to grafting. The order and method for mixing or melt-kneading of other materials added as needed are not particularly limited.

The heating temperature during melt-kneading is preferably 150° C. to 240° C. because the ethylene-α-olefin copolymer melts sufficiently and excessive thermal decomposition or cross-linking reaction does not simultaneously occur. The melt-kneading time (the time period from the addition of the radical polymerization initiator) is usually 30 seconds to 60 minutes.

Examples of apparatuses that can be used to carry out the melt-kneading process include single or multiple screw extruders, Banbury mixers, Plastomills, and heating roll kneaders. From the standpoint of productivity, preferred are methods using a single or twin screw extruder equipped with a decompression device. In order to mix the materials sufficiently uniformly, the melt-kneading process may be repeated multiple times.

### (Styrenic Thermoplastic Elastomer (C))

The styrenic thermoplastic elastomer (C) used in one or more embodiments of the present invention refers to a thermoplastic elastomer which contains a unit derived from styrene, a homologue thereof, or an analogue thereof. Any of known styrenic thermoplastic elastomers can be used. Examples include block copolymers which contain at least one end block derived from styrene, a homologue thereof, or an analogue thereof and further contain as at least one middle block an elastomer block of a conjugated diene or a hydrogenated product thereof; and random copolymers of styrene and a conjugated diene compound, and hydrogenated products thereof.

Preferred specific examples of the styrenic thermoplastic elastomer (C) in one or more embodiments of the present invention include styrene-butadiene diblock copolymers, styrene-butadiene-styrene triblock copolymers, styrene-isoprene diblock copolymers, styrene-isoprene-styrene triblock copolymers, styrene-butadiene random copolymers, hydrogenated styrene-butadiene diblock copolymers, hydrogenated styrene-butadiene-styrene triblock copolymers, hydrogenated styrene-isoprene diblock copolymers, hydrogenated styrene-isoprene-styrene triblock copolymers, hydrogenated styrene-butadiene random copolymers, styrene-isobutylene diblock copolymers, and styrene-isobutylene-styrene triblock copolymers. The styrene block may contain a copolymer of styrene and an aromatic vinyl compound such as α-methylstyrene, in addition to styrene.

The styrenic thermoplastic elastomer (C) preferably contains 1% by weight or more, more preferably 5% by weight or more, particularly preferably 8% by weight or more of styrene-derived units. The styrene-derived unit content is also preferably 20% by weight or less, more preferably 15% by weight or less. A content of more than 20% by weight is not preferred because the resulting composition has reduced adhesion strength. A content of less than 1% by weight is not preferred either from the standpoint of heat resistance.

Among the styrenic thermoplastic elastomers (C) mentioned above, from the standpoints of good heat resistance and good weather resistance, preferred are those in which the unsaturated double bonds in the conjugated diene-based polymer block are partially or wholly hydrogenated. Examples include hydrogenated styrene-isoprene block copolymers such as hydrogenated styrene-isoprene-styrene triblock copolymers (SEPS), hydrogenated styrene-butadiene block copolymers such as hydrogenated styrene-butadiene-styrene triblock copolymers (SEBS), hydrogenated styrene-butadiene random copolymers (HSBR), and hydrogenated styrene-isobutylene-styrene triblock copolymers (SIBS). In view of heat resistance and weather resistance, more preferred are hydrogenated styrene-isoprene-styrene triblock copolymers (SEPS), hydrogenated styrene-butadiene-styrene triblock copolymers (SEBS), hydrogenated styrene-isobutylene-styrene triblock copolymers (SIBS), and hydrogenated styrene-butadiene random copolymers (HSBR). Examples of the styrenic thermoplastic elastomers include commercially available Asaprene, Tufprene, Asaflex, and Tuftec (produced by Asahi Kasei Corporation); Dynaron and JSR-TR (produced by JSR Corporation); Kraton (produced by Kraton Performance Polymers, Inc.); Quintac (Zeon corporation); Hybrar and Septon (produced by Kuraray Co., Ltd.); and SIBSTAR (Kaneka Corporation).

The styrenic thermoplastic elastomers (C) may be used alone or in combinations of two or more.

The amount of the styrenic thermoplastic elastomer (C) per 100 parts by weight of the combined amount of the copolymers (A) and (B) is preferably 1 part by weight or more, more preferably 5 parts by weight or more, still more preferably 10 parts by weight or more. The amount is also preferably 60 parts by weight or less, more preferably 40 parts by weight or less, still more preferably 35 parts by weight or less. An amount of less than 1 part by weight is not preferred because the adhesion strength may be poor. An amount of more than 60 parts by weight is not preferred either from the standpoint of heat resistance because the elasticity of the composition at high temperatures decreases. In addition, an amount of 10 parts by weight or more is preferred because the adhesion strength tends to be higher. An amount of 35 parts by weight or less is also preferred because blocking of the resin pellets tends not to easily occur.

### (Tackifier (D))

Various tackifiers can be used as the tackifier (D) in one or more embodiments of the present invention, and examples include petroleum resins (e.g. aliphatic, alicyclic, and aromatic ones), terpene resins (e.g. polymers of α-pinene, β-pinene, or limonene), aromatic modified terpene resins, rosin resins (e.g. gum rosin, tall oil rosin, wood rosin, hydrogenated rosin, disproportionated rosin, polymerized rosin, maleinized rosin, rosin esters), and terpene phenol resins. These may be used alone or in combinations of two or more. In the case that a modified ethylene-α-olefin is used, alicyclic petroleum resins, terpene resins (e.g. polymers of α-pinene, β-pinene, or limonene), and aromatic modified terpene resins, all of which are free of structures that react with the epoxy groups in the modified ethylene-α-olefin, are preferred among these. Particularly from the standpoints of wettability, workability, and heat resistance, more preferred are aromatic modified terpene resins.

It is difficult to prepare terpene phenol resins or rosin resins having low acid values or low hydroxyl values due to the structures of these resins. Hence, terpene phenol resins and rosin resins can react with the epoxy groups in the melt-kneaded modified resin, which tends to result not only in increase in fish eyes or gels but also increase in the viscosity of the resin composition leading to poor film formability. From the standpoints of adhesion in low-temperature processing, heat resistance, and workability of the adhesive resin composition, the tackifier (D) preferably has a ring and ball softening point of 90° C. to 180° C., more preferably 100° C. to 170° C., still more preferably 110° C. to 160° C., particularly preferably 110° C. to 140° C. A softening point of less than 90° C. may reduce the heat resistance of the adhesive composition, and bring difficulties in melt-kneading with the styrenic thermoplastic elastomer and the ethylene-α-olefin copolymers, as well as excessively increasing the tack at ordinary temperature of the adhesive resin composition, making film forming difficult. Also, a softening point of more than 180° C. may lead to poor adhesion at low temperatures. The tackifiers (D) may be used alone or in combinations of two or more.

The amount of the tackifier (D) per 100 parts by weight of the combined amount of the copolymers (A) and (B) is preferably 1 part by weight or more, more preferably 10 parts by weight or more, still more preferably 20 parts by weight or more. The amount is also preferably 80 parts by weight or less, more preferably 70 parts by weight or less, still more preferably 60 parts by weight or less. An amount of less than 1 part by weight is not preferred because the adhesion strength may be poor. An amount of more than 80 parts by weight is not preferred either because the resulting composition has poor cohesion leading to reduced heat resistance, and the resin composition is difficult to handle in granulation and forming due to its excessively increased tack. In addition, an amount of 20 parts by weight or more is preferred because the adhesion strength tends to be higher. An amount of 60 parts by weight or less is also preferred because the heat resistance tends to be higher.

### (Storage Elastic Modulus G′ of Polyolefin Resin Composition for Hot Melt Adhesives)

The storage elastic modulus G′ at 80° C. (G′(80)) of the polyolefin resin composition for hot melt adhesives according to one or more embodiments of the present invention is preferably 0.8 MPa or more, more preferably 0.9 MPa or more, still more preferably 1.0 MPa or more. The polyolefin resin composition with a storage elastic modulus of less than 0.8 MPa may have poor heat resistance.

Also, the storage elastic modulus G′ at 110° C. (G′(110)) of the polyolefin resin composition for hot melt adhesives is preferably less than 0.8 MPa, more preferably less than 0.6 MPa, still more preferably less than 0.5 MPa. The polyolefin resin composition with a storage elastic modulus of 0.8 MPa or more may have poor wettability on the base material during bonding at low temperatures.

The storage elastic modulus G′ is measured using a dynamic viscoelasticity measuring device in a shear mode at a measurement frequency of 10 Hz and a rate of temperature rise of 4° C./min.

### (Method for Preparing Adhesive Resin Composition)

As for the method for preparing the polyolefin resin composition for hot melt adhesives according to one or more embodiments of the present invention, any of known methods can be used. Melt-kneading is especially preferred as the components are easily mixed uniformly by this method. The melt-kneading can be carried out with apparatuses such as a single or multiple screw extruder, a Banbury mixer, a Plastomill, or a heating roll kneader. From the standpoint of productivity, preferred are methods using a single or twin screw extruder equipped with a decompression device. In order to mix the materials sufficiently uniformly, the melt-kneading process may be repeated multiple times.

The polyolefin resin composition for hot melt adhesives according to one or more embodiments of the present invention may as necessary incorporate other thermoplastic resins, stabilizers such as antioxidants, metal deactivators, phosphorus-containing processing stabilizers, ultraviolet absorbers, ultraviolet stabilizers, fluorescent brighteners, metal soaps, and antacid adsorbents, as well as other additives such as cross-linking agents, chain transfer agents, nucleating agents, lubricants, plasticizers, fillers, reinforcements, pigments, dyes, flame retardants, and antistatic agents.

These stabilizers and additives may each be added to the ethylene-α-olefin copolymers or the styrenic thermoplastic elastomer in advance, or may be added during melt-modification of the ethylene-α-olefin copolymer, or may be added during melt-kneading of the components including the ethylene-α-olefin copolymer (A) and the ethylene-α-olefin copolymer (B), and optionally the styrenic thermoplastic elastomer (C) or the tackifier (D), or may be added in an appropriate manner after preparation of the polyolefin resin composition.

### (Hot Melt Adhesive Film)

The hot melt adhesive film of one or more embodiments of the present invention is obtained by forming the polyolefin resin composition for hot melt adhesives into a film-shaped formed article having heat sealability. The heat sealability refers to the nature of being melt by heat and bonded to an adherend. The thickness of the hot melt adhesive film may be adjusted appropriately according to the application, but is preferably 20 to 200 μm, more preferably 30 to 100 μm, because the desired adhesion and heat resistance are more likely to be obtained.

The hot melt adhesive film of one or more embodiments of the present invention may be prepared by any method such as by obtaining the polyolefin resin composition by melt-kneading, and then forming the composition into a film using any of various extrusion molding machines, injection molding machines, calendering machines, inflation molding machines, roll forming machines, hot press molding machines and other machines.

### (Laminate)

The polyolefin resin composition for hot melt adhesives according to one or more embodiments of the present invention can be bonded to various adherends at relatively low treatment temperatures to produce multi-layer laminates. Examples of materials to which the polyolefin resin composition for hot melt adhesives of one or more embodiments of the present invention can be bonded include cellulosic polymer materials such as paper, cotton, linen, cloth, and wooden boards; synthetic polymer materials, including polyolefin resins such as polypropylene and polyethylene, styrene resins such as polystyrene, styrene-butadiene block copolymers (SBS resins), styrene-acrylonitrile copolymers (AS resins), acrylonitrile-ethylene/propylene-styrene copolymers (AES resins), and acrylonitrile-butadiene-styrene copolymers (ABS resins), polycarbonate resins (PC resins), (meth)acrylic resins, polyester resins, polyamide resins such as nylon and polyurethane, phenol resins, and epoxy resins; and metallic materials such as gold, silver, copper, iron, tin, lead, and aluminum. The material for the adherend may be a mixture or combination of two or more different materials. In the case that the laminate is formed by bonding two different adherends via an adhesive layer made of the polyolefin resin composition for hot melt adhesives of one or more embodiments of the present invention, the materials of the two adherends may be the same as or different from each other. Though the polyolefin resin composition for hot melt adhesives of one or more embodiments of the present invention can show strong adhesion without requiring any surface treatment of the adherend, surface treatment such as surface modification, for example, by plasma or laser, surface oxidation, or etching, or other treatments may be applied as needed.

The laminate obtained as described above can be used for the following applications, for example. It can be suitably used in applications where a covering material and a formed article are used as adherends, such as interior materials for automobiles and the like (e.g. ceiling materials for automobile interiors, door components for automobile interiors, dashboard components for automobile interiors, instrument panels), components for household electrical appliances (e.g. housings for personal computers, frames of flat-screen televisions), and housing materials (e.g. interior wall boards, decorating films). The covering material refers to one that has been formed into a film, a sheet, a foam, or a non-woven or woven material of any type. Examples include decorating polymer sheets made of polyvinyl chloride, various polyolefins, or ABS, polyester non-woven fabrics, raised knits, fabrics, polyurethane artificial leathers, and polyolefin foams formed mainly from polypropylene, polyethylene, polybutylene, or copolymers of these olefins. Examples of the formed article include injection-molded articles of various polymer materials such as ABS, PC/ABS, polyolefins, glass fiber-reinforced polyolefins, and glass fiber-reinforced nylons; and ligneous formed articles and ligneous boards prepared by encasing a material such as wood chips or ligneous powder in a thermosetting resin or a polyolefin resin by hot press molding. The polyolefin resin composition for hot melt adhesives of one or more embodiments of the present invention can show strong adhesion at relatively low temperatures in the range of about 100-130° C., and does not impair the properties such as the texture and feel of the covering material and the formed article in the preparation. Thus, the polyolefin resin composition can be suitably used for decoration of formed articles with decorating sheets as covering materials.

In the preparation of a multi-layer laminate by bonding the covering material such as a decorating sheet and a formed article used as a base material via an adhesive layer made of the polyolefin resin composition for hot melt adhesives of one or more embodiments of the present invention, various forming methods such as heat lamination, vacuum forming, vacuum pressure forming, hot pressing, heat rolling, and hot stamping can be used. Among these, vacuum forming, vacuum pressure forming, and hot stamping are preferred because they can be used to bond a covering material to a curved formed article without impairing the arc shape of the formed article. The curved formed article denotes, among formed articles as made of the above-mentioned materials, one which has a planar arc-shaped surface as the surface to be bonded to the covering material. Such formed articles are used to form shape skeletons in automobile interiors or housings of household electrical appliances.

The laminate may be prepared, for example, by heat laminating the hot melt adhesive film to a covering material and subjecting the resulting covering material to a particular forming process for hot pressing. According to this method, the covering material can be stacked so that it can conform to the shape of the formed article. In particular, vacuum pressure forming is preferred because the formed article can be wrapped with the covering material from the edges of the formed article to the backside of the formed article by applying a compressed air pressure while bonding the cover to the formed article, and further because vacuum pressure forming can also be used to prepare a laminate including a deep-drawn formed article as an adherend.

When vacuum forming, vacuum pressure forming, or hot stamping is used, the adhesive film preferably has a thickness of 20 to 200 μm, more preferably 30 to 100 μm. A thickness of smaller than 20 μm is not preferred because the film has a smaller adhesion area to the formed article and shows insufficient adhesion strength. The film with a thickness of greater than 200 μm has reduced thermal conductivity so that it cannot sufficiently soften within a predetermined time during heating of the covering material, resulting in a decrease in adhesion strength. Also, when the film has the thickness indicated above, not only can a laminate with good appearance be obtained, but the occurrence of poor appearance such as peeling or lateral slippage of the covering material, caused by expansion and contraction of the covering material or the formed article when the laminate is placed in a high temperature environment, can be reduced. Since in the laminate obtained by vacuum pressure forming, the formed article is wrapped with the covering material from the edges to the backside of the formed article, the appearance can be maintained in a higher temperature environment.

### EXAMPLES

In the following, one or more embodiments of the present invention are described in more detail with reference to specific examples and comparative examples. The present invention, however, is not limited to the examples. In the examples and comparative examples, “part(s)” and “%” mean “part(s) by weight” and “% by weight”, respectively.

### (Measurement of Melting Point)

The melting point (° C.) was defined as a temperature corresponding to the top of a peak observed on a melting endothermic curve obtained with a differential scanning calorimeter (DTG-50, produced by Shimadzu Corporation) by warming a sample in a nitrogen atmosphere to 220° C. at a rate of 10° C./min, cooling the sample to 40° C., and then warming the sample again to 220° C. at a rate of 10° C./min.

### (Measurement of Density)

The density (g/cm³) of resin pellets was measured in accordance with the method A (underwater substitution method) set forth in JIS K7112 using a density measuring instrument (Alfa Mirage Co., Ltd.: densimeter ED-120T). The average of three measurements was used.

### (Measurement of Tensile Elastic Modulus)

The polymers shown in Table 1 were each hot pressed under predetermined heating temperature conditions (200° C., 5 MPa) using a hot press machine (Shinto Metal Industries Corporation: compression molding machine NSF-50) to form a sheet having a thickness of about 2 mm. The sheet was cut into a size of the No. 2(⅓) dumbbell set forth in JIS K7113, and subjected to stress-strain analysis with an autograph (Shimadzu Corporation: AGS-X) under the conditions below. When the stresses corresponding to the two specified strain points ε1=0.0005 and ε2=0.0025 were represented by σ1 and σ2, respectively, a value obtained by dividing the difference between the stresses (σ2−σ1) by the difference between the strains (ε2−ε1) was determined and taken as the tensile elastic modulus (MPa). Here, the average of three measurements was used.

Test temperature: 23° C.

Test rate: 1 mm/min

Initial distance between chucks: 27 mm

### (Analysis of Grafted Amount of Glycidyl Methacrylate)

The grafted amount (wt %) of glycidyl methacrylate was analyzed by dissolving pellets of the prepared modified ethylene-propylene copolymer in xylene heated to 110° C., adding dropwise the xylene solution to N,N-dimethylformamide to cause reprecipitation, and titrating the obtained precipitate. The titration was carried out by determining the amount of epoxy groups using perchloric acid (acetic acid solution) as a titrant in a potentiometric titrator (AT-700, Kyoto Electronics Manufacturing Co., Ltd.) in accordance with JIS K7236.

### (Measurement of Storage Elastic Modulus G′)

A 6 mm×5 mm×2 mm prismatic specimen was measured using a dynamic viscoelasticity measuring device (DVA-200, IT Keisoku Seigyo) in a shear mode at a measurement frequency of 10 Hz, a rate of temperature rise of 4° C./min, and a measurement temperature range of −70° C. to 150° C. The storage elastic moduli G′ (MPa) at 80° C. and 110° C. were recorded.

### (Preparation of Adhesive Sample)

### (Adhesion Condition 1)

An adhesive film (60 μm-thick) was laminated onto an ABS resin sheet having a thickness of 0.3 mm using a laminator (LAMIPACKER LPD3204 produced by FUJIPLA Inc.) to prepare an adhesive-backed covering material. Then, the covering material was bonded to a PP base material (2 mm-thick) by a vacuum laminator (module laminator LM-50×50-S produced by NPC Incorporated). The conditions of the vacuum laminator were set as follows: temperature: 150° C., pressure: 2 atmospheres, vacuum time: 6 seconds, press time: 16 seconds, retention time: 0 seconds.

At this time, the temperature of the adhesive layer rose to the range of 114° C. to 118° C.

A 180° peel test was carried out by cutting the obtained laminate to have a width of 25 mm, and peeling the covering material in a direction 180° from the laminate at a pulling rate of 100 mm/min in a 23° C. environment to analyze the strength (N/25 mm) and the peeling mode. The peeling mode is expressed as material failure (fracture of the covering material ABS resin sheet) or interfacial delamination (peeling of the adhesive layer from the PP base material interface of the formed article).

### (Adhesion Condition 2)

An adhesive film (60 μm-thick) was laminated onto an ABS resin sheet having a thickness of 0.3 mm using a laminator (LAMIPACKER LPD3204 produced by FUJIPLA Inc.) to prepare an adhesive-backed covering material. Then, the covering material was bonded to a PP base material (2 mm-thick) by a vacuum laminator (module laminator LM-50×50-S produced by NPC Incorporated). The conditions of the vacuum laminator were set as follows: temperature: 130° C., pressure: 2 atmospheres, vacuum time: 6 seconds, press time: 16 seconds, retention time: 0 seconds.

At this time, the temperature of the adhesive layer rose to the range of 100° C. to 105° C.

A 180° peel test was carried out by cutting the obtained laminate to have a width of 25 mm, and peeling the covering material in a direction 180° from the laminate at a pulling rate of 100 mm/min in a 23° C. environment to analyze the strength (N/25 mm) and the peeling mode. The peeling mode is expressed as material failure (fracture of the covering material ABS resin sheet) or interfacial delamination (peeling of the adhesive layer from the PP base material interface of the formed article).

### (Adhesion Condition 3)

An adhesive film (60 μm-thick) was laminated onto an ABS resin sheet having a thickness of 0.3 mm using a laminator (LAMIPACKER LPD3204 produced by FUJIPLA Inc.) to prepare an adhesive-backed covering material. Then, the covering material was bonded to a PC/ABS base material (2 mm-thick) by a vacuum laminator (module laminator LM-50×50-S produced by NPC Incorporated). The conditions of the vacuum laminator were set as follows: temperature: 150° C., pressure: 2 atmospheres, vacuum time: 6 seconds, press time: 16 seconds, retention time: 0 seconds.

At this time, the temperature of the adhesive layer rose to the range of 114° C. to 118° C.

A 180° peel test was carried out by cutting the obtained laminate to have a width of 25 mm, and peeling the covering material in a direction 180° from the laminate at a pulling rate of 100 mm/min in a 23° C. environment to analyze the strength (N/25 mm) and the peeling mode. The peeling mode is expressed as material failure (fracture of the covering material ABS resin sheet) or interfacial delamination (peeling of the adhesive layer from the PC/ABS base material interface of the formed article).

### (Adhesion Condition 4)

An adhesive-backed covering material was obtained under the same conditions as the adhesion condition 1, and the covering material was bonded to a PP base material (2 mm-thick) by a vacuum pressure forming machine (NGF forming machine produced by Fu-se Vacuum Forming Ltd.). The forming machine consists of the upper and lower parts. The base material was set on the lower part, and the covering material was sandwiched and set between the upper and lower parts. After the components were set, both the upper and lower parts were decompressed to −90 kPa. Then, the covering material was heated with an infrared heater installed on the upper part, and when the covering material was heated to 120° C., the base material was pressed onto the covering material. Subsequently, compressed air was introduced into the upper part to 200 kPa followed by forming.

The laminate thus obtained was subjected to a 180° peel test under the same conditions as the adhesion condition 1.

### (Thermal Creep Test)

The laminate cut to have a width of 25 mm was fixed in an oven so that the base material was placed in a horizontal direction. A weight of 100 g was attached to one end of the decorating film, and the degree of peeling after the lapse of 24 hours in an 80° C. environment was evaluated. At this time, the angle formed by the base material and the straight line connecting the weight and the bonded end face was 90°. The test was performed at N (number of samples)=5. The evaluation criteria were as follows: Good: every sample exhibited a peel distance of shorter than 10 mm, Poor: at least one sample exhibited a peel distance of 10 mm or longer. The “peel distance” used was the longest among the peel distances of the five samples.

### (Blocking Tendency of Resin Pellets)

The resin pellets (5 kg) obtained in each of the examples and comparative examples were loaded into a stainless steel vessel having a size of 300 mm (length)×800 mm (width)×50 mm (height). After the resin pellets were left to stand for 12 hours at 40° C., the state of the pellets was evaluated. The evaluation criteria were as follows: Good: blocking did not occur, Poor: blocking occurred.

### (Film Formability)

The film formability was evaluated based on the amount of neck-in when the melted resin was discharged through a T-die in the process of film formation. The evaluation criteria were as follows: Good: a film was easily formable due to low neck-in, Acceptable: a film was formable although rather high neck-in was observed, Poor: film formation was difficult due to high neck-in.

The conditions in the evaluation were as follows: T-die preset temperature: 170° C., film width: 400 mm, film thickness: 60 μm.

### (Starting Resins Used in Examples and Comparative Examples)

1) Modified ethylene-propylene copolymer A1

Versify 3000 (produced by Dow Chemical Japan Limited) modified with glycidyl methacrylate and styrene

2) Modified ethylene-propylene copolymer A2

Versify 3401.05 (produced by Dow Chemical Japan Limited) modified with glycidyl methacrylate and styrene

3) Ethylene-propylene copolymer A3

Versify 3000 (produced by Dow Chemical Japan Limited)

4) Ethylene-propylene copolymer A4

Versify 3401.05 (produced by Dow Chemical Japan Limited)

5) Ethylene-propylene copolymer B1

Versify 4200 (produced by Dow Chemical Japan Limited)

6) Modified ethylene-propylene copolymer B2

Versify 4200 (produced by Dow Chemical Japan Limited) modified with glycidyl methacrylate and styrene

7) Modified polypropylene

J105G (produced by Prime Polymer Co., Ltd.) modified with glycidyl methacrylate and styrene

8) Styrenic thermoplastic elastomer C1

Septon 2063 (produced by Kuraray Co., Ltd., styrene-derived unit content: 13%)

9) Styrenic thermoplastic elastomer C2

DYNARON 1321P (produced by JSR Corporation, styrene-derived unit content: 10%)

### 10) Tackifier D1

YS resin TO125 (produced by Yasuhara Chemical Co., Ltd., softening point: 125° C.)

### Production Example 1

100 parts of ethylene-propylene copolymer A3 and 0.5 parts of 1,3-di(t-butylperoxyisopropyl)benzene (one-minute half-life temperature: 175° C.) were fed into a twin screw extruder (46 mmφ, L/D=60, Kobe Steel, Ltd., product name: HYPERKTX 46) set to a cylinder temperature of 200° C. and a screw speed of 150 rpm, followed by melt-kneading. Then, 3 parts of glycidyl methacrylate and 3 parts of styrene were added from an inlet in the middle of the cylinder, and they were melt-kneaded to obtain modified ethylene-propylene copolymer A1. The grafted amount of glycidyl methacrylate in the obtained modified ethylene-propylene copolymer A1 was 0.8 wt %.

### Production Example 2

100 parts of ethylene-propylene copolymer A4 and 0.5 parts of 1,3-di(t-butylperoxyisopropyl)benzene (one-minute half-life temperature: 175° C.) were fed into a twin screw extruder (46 mmφ, L/D=60, Kobe Steel, Ltd., product name: HYPERKTX 46) set to a cylinder temperature of 200° C. and a screw speed of 150 rpm, followed by melt-kneading. Then, 3 parts of glycidyl methacrylate and 3 parts of styrene were added from an inlet in the middle of the cylinder, and they were melt-kneaded to obtain modified ethylene-propylene copolymer A2. The grafted amount of glycidyl methacrylate in the obtained modified ethylene-propylene copolymer A2 was 0.8 wt %.

### Production Example 3

100 parts of ethylene-propylene copolymer B1 and 0.5 parts of 1,3-di(t-butylperoxyisopropyl)benzene (one-minute half-life temperature: 175° C.) were fed into a twin screw extruder (46 mmφ, L/D=60, Kobe Steel, Ltd., product name: HYPERKTX 46) set to a cylinder temperature of 200° C. and a screw speed of 150 rpm, followed by melt-kneading. Then, 3 parts of glycidyl methacrylate and 3 parts of styrene were added from an inlet in the middle of the cylinder, and they were melt-kneaded to obtain modified ethylene-propylene copolymer B2. The grafted amount of glycidyl methacrylate in the obtained modified ethylene-propylene copolymer B2 was 0.8 wt %.

### Production Example 4

100 parts of polypropylene (J105G, Prime Polymer Co., Ltd.) and 0.5 parts of 1,3-di(t-butylperoxyisopropyl)-benzene (one-minute half-life temperature: 175° C.) were fed into a twin screw extruder (46 mmφ, L/D=60, Kobe Steel, Ltd., product name: HYPERKTX 46) set to a cylinder temperature of 200° C. and a screw speed of 150 rpm, followed by melt-kneading. Then, 3 parts of glycidyl methacrylate and 3 parts of styrene were added from an inlet in the middle of the cylinder, and they were melt-kneaded to obtain a modified polypropylene. The grafted amount of glycidyl methacrylate in the obtained modified polypropylene was 0.8 wt %.

The physical properties (density, melting point, tensile elastic modulus, grafted amount of glycidyl methacrylate, ethylene content) of ethylene-propylene copolymers A3, A4, and B1, the modified ethylene-propylene copolymers A1, A2, and B2 and modified polypropylene obtained in Production Examples 1 to 4 are shown in Table 1.

TABLE 1

| | | A1 | A2 | A3 | A4 | B1 | B2 | Modified polypropylene |
|---|---|---|---|---|---|---|---|---|
| Melting point | ° C. | 118 | 140 | 118 | 140 | 86 | 86 | 160 |
| Density | g/cm³ | 0.89 | 0.87 | 0.89 | 0.87 | 0.87 | 0.87 | 0.90 |
| Tensile elastic modulus | MPa | 440 | 10 | 500 | 10 | 190 | 190 | 1700 |
| Grafted amount of glycidyl | wt % | 0.8 | 0.8 | | | | 0.8 | 0.8 |
| methacrylate | | | | | | | | |
| Ethylene content | wt % | 5 | 15 | 5 | 15 | 9 | 9 | 0 |

### Example 1

50 parts of ethylene-propylene copolymer A3 and 50 parts of ethylene-propylene copolymer B1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 2

30 parts of ethylene-propylene copolymer A3 and 70 parts of ethylene-propylene copolymer B1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 and Table 4 show the results.

### Example 3

50 parts of ethylene-propylene copolymer A3, 50 parts of ethylene-propylene copolymer B1, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 4

30 parts of ethylene-propylene copolymer A3, 70 parts of ethylene-propylene copolymer B1, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 5

50 parts of the modified ethylene-propylene copolymer A1 obtained in Production Example 1 and 50 parts of ethylene-propylene copolymer B1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 6

30 parts of the modified ethylene-propylene copolymer A1 obtained in Production Example 1 and 70 parts of ethylene-propylene copolymer B1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 7

50 parts of the modified ethylene-propylene copolymer A1 obtained in Production Example 1, 50 parts of ethylene-propylene copolymer B1, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 8

30 parts of the modified ethylene-propylene copolymer A1 obtained in Production Example 1, 70 parts of ethylene-propylene copolymer B1, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 2 shows the results.

### Example 9

50 parts of ethylene-propylene copolymer A3, 50 parts of ethylene-propylene copolymer B1, and 25 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 3 shows the results.

### Example 10

30 parts of ethylene-propylene copolymer A3, 70 parts of ethylene-propylene copolymer B1, and 25 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 3 shows the results.

### Example 11

50 parts of the modified ethylene-propylene copolymer A1 obtained in Production Example 1, 50 parts of ethylene-propylene copolymer B1, and 25 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 3 shows the results.

### Example 12

30 parts of the modified ethylene-propylene copolymer A1 obtained in Production Example 1, 70 parts of ethylene-propylene copolymer B1, and 25 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 3 shows the results.

### Example 13

30 parts of the modified ethylene-propylene copolymer A1 obtained in Production Example 1, 70 parts of ethylene-propylene copolymer B1, 25 parts of tackifier D1, and 10 parts of styrenic thermoplastic elastomer C1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 3 shows the results.

### Example 14

30 parts of the modified ethylene-propylene copolymer A1 obtained in Production Example 1, 70 parts of ethylene-propylene copolymer B1, 50 parts of tackifier D1, and 20 parts of styrenic thermoplastic elastomer C1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 3 shows the results.

### Example 15

30 parts of the modified ethylene-propylene copolymer A1 obtained in Production Example 1, 70 parts of ethylene-propylene copolymer B1, 50 parts of tackifier D1, and 20 parts of styrenic thermoplastic elastomer C2 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 4 shows the results.

### Example 16

30 parts of ethylene-propylene copolymer A3, 70 parts of ethylene-propylene copolymer B1, and 20 parts of styrenic thermoplastic elastomer C2 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 4 shows the results.

### Example 17

30 parts of ethylene-propylene copolymer A3, 70 parts of ethylene-propylene copolymer B1, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 4 shows the results.

### Example 18

30 parts of ethylene-propylene copolymer A3, 70 parts of modified ethylene-propylene copolymer B2, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 4 shows the results.

### Example 19

30 parts of modified ethylene-propylene copolymer A1, 70 parts of modified ethylene-propylene copolymer B2, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 4 shows the results. Also, Table 7 shows the evaluation results in the case of vacuum pressure forming.

### Example 20

30 parts of modified ethylene-propylene copolymer A1, 70 parts of modified ethylene-propylene copolymer B2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 21

30 parts of modified ethylene-propylene copolymer A1, 70 parts of modified ethylene-propylene copolymer B2, 30 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 22

30 parts of modified ethylene-propylene copolymer A1, 70 parts of modified ethylene-propylene copolymer B2, 50 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 23

30 parts of modified ethylene-propylene copolymer A1, 70 parts of modified ethylene-propylene copolymer B2, and 20 parts of styrenic thermoplastic elastomer C2 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 24

30 parts of modified ethylene-propylene copolymer A1, 70 parts of modified ethylene-propylene copolymer B2, 20 parts of styrenic thermoplastic elastomer C2, and 25 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 25

30 parts of modified ethylene-propylene copolymer A1, 70 parts of modified ethylene-propylene copolymer B2, 20 parts of styrenic thermoplastic elastomer C2, and 75 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 26

20 parts of modified ethylene-propylene copolymer A1, 80 parts of modified ethylene-propylene copolymer B2, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Example 27

40 parts of modified ethylene-propylene copolymer A1, 60 parts of modified ethylene-propylene copolymer B2, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results. Also, Table 7 shows the evaluation results in the case of vacuum pressure forming.

### Example 28

60 parts of modified ethylene-propylene copolymer A1, 40 parts of modified ethylene-propylene copolymer B2, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 5 shows the results.

### Comparative Example 1

80 parts of the modified ethylene-propylene copolymer A2 obtained in Production Example 2, 50 parts of tackifier D1, and 20 parts of styrenic thermoplastic elastomer C1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 6 shows the results.

### Comparative Example 2

Ethylene-propylene copolymer A3 was formed into a film having a thickness of 60 μm through a T-die to obtain a hot melt adhesive film. It was evaluated as described above in the evaluation items: adhesion evaluation, thermal creep test, blocking tendency of resin, and film formability. Table 6 shows the results. In the evaluation of blocking tendency, pellets of ethylene-propylene copolymer A3 were used.

### Comparative Example 3

100 parts of modified ethylene-propylene copolymer B2, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 6 shows the results. Also, Table 7 shows the evaluation results in the case of vacuum pressure forming.

### Comparative Example 4

100 parts of modified ethylene-propylene copolymer A1, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 6 shows the results. Also, Table 7 shows the evaluation results in the case of vacuum pressure forming.

### Comparative Example 5

30 parts of modified ethylene-propylene copolymer A1, 70 parts of the modified polyolefin obtained in Production Example 4, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 6 shows the results.

### Comparative Example 6

70 parts of modified ethylene-propylene copolymer B2, 30 parts of the modified polyolefin obtained in Production Example 4, 20 parts of styrenic thermoplastic elastomer C2, and 50 parts of tackifier D1 were melt-kneaded in a twin screw extruder (44 mmφ, L/D=38.5, The Japan Steel Works, Ltd., product name: TEX44XCT) set to a cylinder temperature of 180° C., to obtain pellets of a polyolefin resin composition. The polyolefin resin composition was formed into a film having a thickness of 60 μm through a T-die to obtain a hot melt adhesive film. The composition was evaluated as described above in the evaluation items: adhesion evaluation, thermal creep test, blocking tendency of resin, and film formability. Table 6 shows the results. Also, Table 7 shows the evaluation results in the case of vacuum pressure forming.

TABLE 2

| | | | Examples | | | | | | | |
|---|---|---|---|---|---|---|---|---|---|---|
| | | | 1 | 2 | 3 | 4 | 5 | 6 | 7 | 8 |
| Modified ethylene-propylene copolymer A1 | | | | | | | 50 | 30 | 50 | 30 |
| Ethylene-propylene copolymer A3 | | | 50 | 30 | 50 | 30 | | | | |
| Ethylene-propylene copolymer B1 | | | 50 | 70 | 50 | 70 | 50 | 70 | 50 | 70 |
| Tackifier D1 | | | | | 50 | 50 | | | 50 | 50 |
| Storage elastic modulus at 80° C. (G′) [MPa] | | | 7 | 4.5 | 2.1 | 1.1 | 7 | 4.5 | 2.1 | 1.1 |
| Storage elastic modulus at 110° C. (G′) [MPa] | | | 0.43 | 0.17 | 0.08 | 0.071 | 0.43 | 0.17 | 0.08 | 0.071 |
| Adhesion evaluation | 180° peel test | Strength [N/25 mm] | — | — | — | — | — | — | — | — |
| (adhesion condition 1) | | Peeling mode | Material | Material | Material | Material | Material | Material | Material | Material |
| PP base material, | | | failure | failure | failure | failure | failure | failure | failure | failure |
| 150° C. | 80° C. thermal | Evaluation | Good | Good | Good | Good | Good | Good | Good | Good |
| | creep test | Peel distance [mm] | 0 | 0 | 0 | 0 | 0 | 0 | 0 | 0 |

| | | | | | | | | |
|---|---|---|---|---|---|---|---|---|
| Blocking tendency of resin pellets | Good | Good | Good | Good | Good | Good | Good | Good |
| Film formability | Good | Good | Good | Good | Good | Good | Good | Good |

TABLE 3

| | | | Examples | | | | | |
|---|---|---|---|---|---|---|---|---|
| | | | 9 | 10 | 11 | 12 | 13 | 14 |
| Modified ethylene-propylene copolymer A1 | | | | | 50 | 30 | 30 | 30 |
| Ethylene-propylene copolymer A3 | | | 50 | 30 | | | | |
| Ethylene-propylene copolymer B1 | | | 50 | 70 | 50 | 70 | 70 | 70 |
| Styrenic thermoplastic elastomer C1 | | | | | | | 10 | 20 |
| Tackifier D1 | | | 25 | 25 | 25 | 25 | 25 | 50 |
| Storage elastic modulus at 80° C. (G′) [MPa] | | | 4.1 | 2.5 | 4.1 | 2.5 | 1.9 | 1.3 |
| Storage elastic modulus at 110° C. (G′) [MPa] | | | 0.16 | 0.09 | 0.16 | 0.09 | 0.076 | 0.065 |
| Adhesion evaluation | 180° peel test | Strength [N/25 mm] | — | — | — | — | — | — |
| (adhesion condition 1) | | Peeling mode | Material | Material | Material | Material | Material | Material |
| PP base material, 150° C. | | | failure | failure | failure | failure | failure | failure |
| | 80° C. thermal creep test | Evaluation | Good | Good | Good | Good | Good | Good |
| | | Peel distance [mm] | 0 | 0 | 0 | 0 | 0 | 0 |

| | | | | | | |
|---|---|---|---|---|---|---|
| Blocking tendency of resin pellets | Good | Good | Good | Good | Good | Good |
| Film formability | Good | Good | Good | Good | Good | Good |

TABLE 4

| | | | Examples | | | | | |
|---|---|---|---|---|---|---|---|---|
| | | | 2 | 15 | 16 | 17 | 18 | 19 |
| Modified ethylene-propylene copolymer A1 | | | | 30 | | | | 30 |
| Ethylene-propylene copolymer A3 | | | 30 | | 30 | 30 | 30 | |
| Ethylene-propylene copolymer B1 | | | 70 | 70 | 70 | 70 | | |
| Modified ethylene-propylene copolymer B2 | | | | | | | 70 | 70 |
| Styrenic thermoplastic elastomer C2 | | | | 20 | 20 | 20 | 20 | 20 |
| Tackifier D1 | | | | 50 | | 50 | 50 | 50 |
| Storage elastic modulus at 80° C. (G′) [MPa] | | | 4.5 | 1.2 | 3.3 | 1.4 | 1.3 | 1.3 |
| Storage elastic modulus at 110° C. (G′) [MPa] | | | 0.17 | 0.07 | 0.24 | 0.088 | 0.08 | 0.094 |
| Adhesion evaluation | 180° peel test | Strength [N/25 mm] | — | — | — | — | — | — |
| (adhesion condition 1) | | Peeling mode | Material | Material | Material | Material | Material | Material |
| PP base material, | | | failure | failure | failure | failure | failure | failure |
| 150° C. | 80° C. thermal creep test | Evaluation | Good | Good | Good | Good | Good | Good |
| | | Peel distance [mm] | 0 | 0 | 0 | 0 | 0 | 0 |
| Adhesion evaluation | 180° peel test | Strength [N/25 mm] | 5 | — | 10 | — | — | — |
| (adhesion condition 2) | | Peeling mode | Interfacial | Material | Interfacial | Material | Material | Material |
| PP base material, | | | delamination | failure | delamination | failure | failure | failure |
| 130° C. | 80° C. thermal creep test | Evaluation | Good | Good | Good | Good | Good | Good |
| | | Peel distance [mm] | 9 | 0 | 6 | 0 | 0 | 0 |
| Adhesion evaluation | 180° peel test | Strength [N/25 mm] | 5 | — | 8 | — | — | — |
| (adhesion condition 3) | | Peeling mode | Interfacial | Material | Interfacial | Material | Material | Material |
| PC/ABS base material, | | | delamination | failure | delamination | failure | failure | failure |
| 150° C. | 80° C. thermal creep test | Evaluation | Poor | Good | Good | Good | Good | Good |
| | | Peel distance [mm] | >10 | 4 | 9 | 6 | 2 | 0 |

| | | | | | | |
|---|---|---|---|---|---|---|
| Blocking tendency of resin pellets | Good | Good | Good | Good | Good | Good |
| Film formability | Good | Good | Good | Good | Good | Good |

TABLE 5

| | | | Examples | | | | |
|---|---|---|---|---|---|---|---|
| | | | 20 | 21 | 22 | 23 | 24 |
| Modified ethylene-propylene copolymer A1 | | | 30 | 30 | 30 | 30 | 30 |
| Modified ethylene-propylene copolymer B2 | | | 70 | 70 | 70 | 70 | 70 |
| Styrenic thermoplastic elastomer C2 | | | | 30 | 50 | 20 | 20 |
| Tackifier D1 | | | 50 | 50 | 50 | | 25 |
| Storage elastic modulus at 80° C. (G′) [MPa] | | | 1.4 | 1.3 | 1.3 | 3.5 | 1.9 |
| Storage elastic modulus at 110° C. (G′) [MPa] | | | 0.048 | 0.082 | 0.11 | 0.19 | 0.094 |
| Adhesion evaluation | 180° peel test | Strength [N/25 mm] | — | — | — | — | — |
| (adhesion condition 1) | | Peeling mode | Material | Material | Material failure | Material failure | Material |
| PP base material, 150° C. | | | failure | failure | | | failure |
| | 80° C. thermal | Evaluation | Good | Good | Good | Good | Good |
| | creep test | Peel distance [mm] | 0 | 0 | 0 | 0 | 0 |
| Adhesion evaluation | 180° peel test | Strength [N/25 mm] | 8 | — | — | 10 | — |
| (adhesion condition 2) | | Peeling mode | Interfacial | Material | Material failure | Interfacial | Material |
| PP base material, 130° C. | | | delamination | failure | | delamination | failure |
| | 80° C. thermal | Evaluation | Good | Good | Good | Good | Good |
| | creep test | Peel distance [mm] | 0 | 0 | 0 | 0 | 0 |

| | | | | | |
|---|---|---|---|---|---|
| Blocking tendency of resin pellets | Good | Good | Acceptable | Good | Good |
| Film formability | Good | Good | Good | Good | Good |

| | | | | Examples | | | |
|---|---|---|---|---|---|---|---|
| | | | | 25 | 26 | 27 | 28 |
| Modified ethylene-propylene copolymer A1 | | | | 30 | 20 | 40 | 60 |
| Modified ethylene-propylene copolymer B2 | | | | 70 | 80 | 60 | 40 |
| Styrenic thermoplastic elastomer C2 | | | | 20 | 20 | 20 | 20 |
| Tackifier D1 | | | | 75 | 50 | 50 | 50 |
| Storage elastic modulus at 80° C. (G′) [MPa] | | | | 1.2 | 1.2 | 1.6 | 1.9 |
| Storage elastic modulus at 110° C. (G′) [MPa] | | | | 0.059 | 0.066 | 0.074 | 0.14 |
| | Adhesion evaluation | 180° peel test | Strength [N/25 mm] | — | — | — | — |
| | (adhesion condition 1) | | Peeling mode | Material failure | Material failure | Material | Material |
| | PP base material, 150° C. | | | | | failure | failure |
| | | 80° C. thermal | Evaluation | Good | Good | Good | Good |
| | | creep test | Peel distance [mm] | 0 | 0 | 0 | 0 |
| | Adhesion evaluation | 180° peel test | Strength [N/25 mm] | — | — | — | 14 |
| | (adhesion condition 2) | | Peeling mode | Material failure | Material failure | Material | Interfacial |
| | PP base material, 130° C. | | | | | failure | delamination |
| | | 80° C. thermal | Evaluation | Good | Good | Good | Good |
| | | creep test | Peel distance [mm] | 0 | 0 | 0 | 0 |

| | | | | |
|---|---|---|---|---|
| Blocking tendency of resin pellets | Good | Good | Good | Good |
| Film formability | Acceptable | Acceptable | Good | Good |

TABLE 6

| | | | Comparative Examples | | | | | |
|---|---|---|---|---|---|---|---|---|
| | | | 1 | 2 | 3 | 4 | 5 | 6 |
| Modified ethylene-propylene copolymer A1 | | | | | | 100 | 30 | |
| Modified ethylene-propylene copolymer A2 | | | 80 | | | | | |
| Ethylene-propylene copolymer A3 | | | | 100 | | | | |
| Modified ethylene-propylene copolymer B2 | | | | | 100 | | | 70 |
| Modified polypropylene | | | | | | | 70 | 30 |
| Styrenic thermoplastic elastomer C1 | | | 20 | | | | | |
| Styrenic thermoplastic elastomer C2 | | | | | 20 | 20 | 20 | 20 |
| Tackifier D1 | | | 50 | | 50 | 50 | 50 | 50 |
| Storage elastic modulus at 80° C. (G′) [MPa] | | | 0.4 | 18 | 0.54 | 3.2 | 8 | 4 |
| Storage elastic modulus at 110° C. (G′) [MPa] | | | 0.13 | 4.3 | 0.058 | 0.38 | 3 | 1 |
| Adhesion evaluation | 180° peel test | Strength [N/25 mm] | 65 | 8 | — | 7 | 0 | 0 |
| (adhesion condition 1) | | Peeling mode | Interfacial | Interfacial | Material | Interfacial | Interfacial | Interfacial |
| PP base material, 150° C. | | | delamination | delamination | failure | delamination | delamination | delamination |
| | 80° C. thermal | Evaluation | Poor | Poor | Poor | Poor | Poor | Poor |
| | creep test | Peel distance [mm] | >10 | >10 | >10 | >10 | >10 | >10 |
| Adhesion evaluation | 180° peel test | Strength [N/25 mm] | 40 | 1 | — | 1 | 0 | 0 |
| (adhesion condition 2) | | Peeling mode | Interfacial | Interfacial | Matarial | Interfacial | Interfacial | Interfacial |
| PP base material, 130° C. | | | delamination | delamination | failure | delamination | delamination | delamination |
| | 80° C. thermal | Evaluation | Poor | Poor | Poor | Poor | Poor | Poor |
| | creep test | Peel distance [mm] | >10 | >10 | >10 | >10 | >10 | >10 |

| | | | | | | |
|---|---|---|---|---|---|---|
| Blocking tendency of resin pellets | Good | Good | Poor | Good | Good | Good |
| Film formability | Good | Good | Poor | Good | Good | Good |

TABLE 7

| | | | Examples | | Comaprative Examples | | |
|---|---|---|---|---|---|---|---|
| | | | 19 | 27 | 3 | 4 | 6 |
| Modified ethylene-propylene copolymer A1 | | | 30 | 40 | | 100 | |
| Modified ethylene-propylene copolymer B2 | | | 70 | 60 | 100 | | 70 |
| Modified polypropylene | | | | | | | 30 |
| Styrenic thermoplastic elastomoer C2 | | | 20 | 20 | 20 | 20 | 20 |
| Tackifier D1 | | | 50 | 50 | 50 | 50 | 50 |
| Storage elastic modulus at 80° C. (G′) [MPa] | | | 1.3 | 1.6 | 0.54 | 3.2 | 4 |
| Storage elastic modulus at 110° C. (G′) [MPa] | | | 0.094 | 0.074 | 0.058 | 0.38 | 1 |
| Adhesion evaluation | 180° peel test | Strength [N/25 mm] | — | — | — | 4 | 1 |
| (adhesion condition 4) | | Peeling mode | Material | Material | Material | Interfacial | Interfacial |
| | | | failure | failure | failure | delamination | delamination |
| | 80° C. thermal creep test | Evaluation | Good | Good | Poor | Poor | Poor |
| | | Peel distance [mm] | 0 | 0 | >10 | >10 | >10 |

| | | | | | |
|---|---|---|---|---|---|
| Blocking tendency of resin pellets | Good | Good | Poor | Good | Good |
| Film formability | Good | Good | Poor | Good | Good |

Every example showed good results in the 180° peel test and thermal creep test. As shown in the comparative examples, the compositions containing neither of the ethylene-α-olefin copolymers (A) and (B) did not show satisfactory results on all the items evaluated.

Example 16 in which a styrenic thermoplastic elastomer was added to the resin composition of Example 2 showed better results on 180° peel strength and thermal creep test under the adhesion conditions 2 and 3. Also, Example 17 in which a styrenic thermoplastic elastomer and a tackifier were added to the resin composition of Example 2 showed even better results on 180° peel strength and thermal creep test.

As shown in Examples 15 and 17 to 19, as for the tests in which a PC/ABS base material having high polarity was used as an adherend (adhesion condition 3), the formulations using a modified ethylene-α-olefin copolymer (Examples 15, 18, and 19) showed better results in the thermal creep test than the formulation using an unmodified resin (Example 17). In addition, Example 19 in which both of the copolymers (A) and (B) were modified showed particularly good results.

As shown in Examples 19 and 20 to 22, Example 20 in which no styrenic thermoplastic elastomer was added showed rather poor results on 180° peel strength and thermal creep test when the composition was bonded at a low temperature (adhesion condition 2). On the other hand, Example 22 in which the number of parts added was large showed rather poor results on the blocking tendency of resin pellets.

As shown in Examples 19 and 23 to 25, Example 23 in which no tackifier was added showed rather poor results on 180° peel strength when the composition was bonded at a low temperature (adhesion condition 2). On the other hand, Example 25 in which the number of parts added was large showed rather poor film formability.

As shown in Examples 19 and 26 to 28, as for the proportions of the ethylene-α-olefin copolymers (A) and (B), Example 28 in which the proportion of the copolymer (A) was higher showed rather poor 180° peel strength when the composition was bonded at a low temperature (adhesion condition 2). On the other hand, Example 26 in which the proportion of the copolymer (A) was lower showed rather poor results on thermal creep test and film formability when the composition was bonded at a low temperature (adhesion condition 2).

As shown in Comparative Examples 1 to 4, when the ethylene-α-olefin copolymer (A) or (B) was not used, the thermal creep test results were poor. Also, the 180° peel strength was poor in Comparative Examples 2 and 4.

As shown in Comparative Examples 5 and 6, when a polyolefin having a high melting point was used in place of the ethylene-α-olefin copolymer (A) or (B), the results on 180° peel strength and thermal creep test were both poor.

These hot melt adhesive films were also subjected to low-temperature adhesion evaluation after vacuum pressure forming. Both Examples 19 and 27 showed good results in the 180° peel test and thermal creep test, and gave laminates excellent in adhesion and heat resistance through vacuum pressure forming as well. In contrast, Comparative Example 3 showed good results in the 180° peel test, but showed 10 mm or more peeling in the 80° C. thermal creep test, while Comparative Examples 4 and 6 showed unsatisfactory results with insufficient strength in the 180° peel test and 10 mm or more peeling in the 80° C. thermal creep test.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A polyolefin resin composition for hot melt adhesives, comprising:
5 to 95% by weight of (A) an ethylene-α-olefin copolymer having a melting point of at least 100° C. but not more than 140° C.; and
5 to 95% by weight of (B) an ethylene-α-olefin copolymer having a melting point of at least 70° C. but less than 100° C.

2. The polyolefin resin composition for hot melt adhesives according to claim 1, further comprising 1 to 60 parts by weight of (C) a styrenic thermoplastic elastomer per 100 parts by weight of the combined amount of the copolymers (A) and (B).

3. The polyolefin resin composition for hot melt adhesives according to claim 1, further comprising 1 to 80 parts by weight of (D) a tackifier per 100 parts by weight of the combined amount of the copolymers (A) and (B).

4. The polyolefin resin composition for hot melt adhesives according to claim 1, wherein the polyolefin resin composition has a storage elastic modulus at 80° C., G′(80), of 0.8 MPa or more as measured in a shear mode at a frequency of 10 Hz, and a storage elastic modulus at 110° C., G′(110), of less than 0.8 MPa as measured in a shear mode at a frequency of 10 Hz.

5. The polyolefin resin composition for hot melt adhesives according to claim 1, wherein the ethylene-α-olefin copolymer (A) has a tensile elastic modulus of at least 300 MPa but not more than 700 MPa, and the ethylene-α-olefin copolymer (B) has a tensile elastic modulus of at least 50 MPa but less than 300 MPa.

6. The polyolefin resin composition for hot melt adhesives according to claim 1, wherein at least one of the ethylene-α-olefin copolymer (A) or the ethylene-α-olefin copolymer (B) is a modified ethylene-α-olefin copolymer which has been graft-modified with (a) an unsaturated carboxylic acid or a derivative thereof, and (b) an aromatic vinyl monomer.

7. The polyolefin resin composition for hot melt adhesives according to claim 1, wherein at least one of the ethylene-α-olefin copolymer (A) or the ethylene-α-olefin copolymer (B) is an ethylene-propylene copolymer.

8. The polyolefin resin composition for hot melt adhesives according to claim 1, wherein the ethylene-α-olefin copolymer (A) comprises 3 to 10% by weight of ethylene-derived units.

9. The polyolefin resin composition for hot melt adhesives according to claim 1, wherein the ethylene-α-olefin copolymer (B) comprises 5 to 15% by weight of ethylene-derived units.

10. The polyolefin resin composition for hot melt adhesives according to claim 2, wherein the styrenic thermoplastic elastomer (C) comprises 20% by weight or less of styrene-derived units.

11. The polyolefin resin composition for hot melt adhesives according to claim 2, wherein the styrenic thermoplastic elastomer (C) is at least one selected from the group consisting of hydrogenated styrene-isoprene block copolymers, hydrogenated styrene-butadiene block copolymers, and hydrogenated styrene-butadiene random copolymers.

12. The polyolefin resin composition for hot melt adhesives according to claim 3, wherein the tackifier (D) is at least one selected from the group consisting of terpene resins, aromatic modified terpene resins, and alicyclic petroleum resins.

13. A hot melt adhesive film, comprising;
the polyolefin resin composition for hot melt adhesives according to claim 1,
the hot melt adhesive film having a thickness of 20 to 200 μm.

14. A laminate, comprising;
the polyolefin resin composition for hot melt adhesives according to claim 1.

15. The hot melt adhesive film according to claim 13, which is used in vacuum forming, vacuum pressure forming, or hot stamping.
